(19) United States
(12) Patent Application Publication
(10) Pub. No.: US 2026/0084429 A1
(43) Pub. Date: Mar. 26, 2026

(54) INK EJECTION DEVICE FOR REMOVING INK FROM NOZZLE SURFACE USING WIPERS

(71) Applicant: BROTHER KOGYO KABUSHIKI KAISHA, Nagoya (JP)

(72) Inventor: Mikio OGAWA, Nagoya (JP)

(73) Assignee: BROTHER KOGYO KABUSHIKI KAISHA, Nagoya (JP)

(21) Appl. No.: 19/295,782

(22) Filed: Aug. 11, 2025

(30) Foreign Application Priority Data
Sep. 26, 2024 (JP) 2024-167527

(51) Int. Cl. B41J 2/165; C09D 11/037; C09D 11/101

(52) U.S. Cl. CPC B41J 2/16552; B41J 2/16511; B41J 2/16523; C09D 11/037; C09D 11/101; B41J 2002/16558; B41J 2002/16594

(57) ABSTRACT

An ink ejection device includes a head, a wipe unit, and a drive assembly. The head has a nozzle surface in which a nozzle is open, and is configured to eject ink from the nozzle. The wipe unit is configured to wipe the nozzle surface. The drive assembly is configured to move the head and the wipe unit relative to each other along a first direction. The wipe unit includes a discharge portion configured to discharge cleaning liquid to the nozzle surface, and a first wiper and a second wiper configured to come into contact with the nozzle surface. The discharge portion, the first wiper, and the second wiper are arranged in this order in the first direction.

### REFERENCE TO RELATED APPLICATIONS

This application claims priority from Japanese Patent Application No. 2024-167527 filed on Sep. 26, 2024. The entire content of the priority application is incorporated herein by reference.

### BACKGROUND ART

For instance, a wiping device configured to supply cleaning liquid from a supply plate before a wipe blade reaches a head nozzle is known. In such a configuration, the cleaning liquid spreads between the wipe blade and a nozzle forming surface (hereinafter simply referred to as the “nozzle surface”) in which the head nozzle is formed, thereby bringing the wipe blade into a wetted condition. Subsequently, the wipe blade moves while in contact with the nozzle surface, whereby the nozzle surface is wiped. As a result, ink adhering to the nozzle surface is removed.

### SUMMARY

In the known wiping device, ink adhering to the nozzle surface may become hardened ink (i.e., ink that has solidified and become firmly attached to the nozzle surface) or high-viscosity ink due to drying. In such a case, it may be difficult for the known wiping device to remove the hardened ink and the high-viscosity ink from the nozzle surface.

Aspects of the present disclosure are advantageous in providing one or more improved techniques for an ink ejection device that enable hardened ink and high-viscosity ink adhering to a nozzle surface to be easily removed from the nozzle surface using wipers.

According to aspects of the present disclosure, an ink ejection device is provided, which includes a head, a wipe unit, and a drive assembly. The head has a nozzle surface in which a nozzle is open. The head is configured to eject ink from the nozzle. The wipe unit is configured to wipe the nozzle surface. The drive assembly is configured to move the head and the wipe unit relative to each other along a first direction. The wipe unit includes a discharge portion configured to discharge cleaning liquid to the nozzle surface. The wipe unit further includes a first wiper and a second wiper configured to come into contact with the nozzle surface. The discharge portion, the first wiper, and the second wiper are arranged in this order in the first direction.

### BRIEF DESCRIPTION OF DRAWINGS

FIG. 1 is a perspective view of a printer.

FIG. 2 schematically illustrates an internal configuration of the printer.

FIG. 3 is a plan view of a belt drive mechanism configured to move a carriage along a left-right direction.

FIG. 4 illustrates a process in which a cap moves upward and comes into close contact with a nozzle surface.

FIG. 5 is a cross-sectional view of a wipe unit taken along a plane orthogonal to a front-rear direction of the printer.

FIG. 6 is a partial schematic view of the wipe unit as viewed from above.

FIG. 7 illustrates a horizontal wiping force F1 of a second wiper, an adhesion force F2 of hardened ink, and a maximum static friction force F3 acting between the hardened ink and the nozzle surface.

FIG. 8 illustrates a method for measuring the horizontal wiping force F1.

FIG. 9 schematically illustrates a state in which the wipe unit is connected to a cleaning liquid tank 17 and a waste ink tank 81.

FIG. 10 is a functional block diagram of the printer.

FIG. 11 is a flowchart illustrating a procedure of a maintenance process.

FIG. 12 illustrates a state in which a first wiper and the second wiper are wiping the nozzle surface.

### DESCRIPTION

It is noted that various connections are described between elements in the following description. These connections, unless specified otherwise, may be either direct or indirect, and this specification is not intended to be limiting in that respect. Aspects of the present disclosure may be implemented using circuits (such as application-specific integrated circuits) or computer software stored on computer-readable media, including but not limited to RAMs, ROMs, flash memories, EEPROMs, CD media, DVD media, temporary storage, hard disk drives, floppy drives, permanent storage, and the like.

As used herein, the term “processor” encompasses a single processor or a group of multiple processors, which may include a single-core processor, a multi-core processor, multiple processors within a single device, or multiple processors in wired or wireless communication with each other. Such processors may be locally or remotely distributed and may operate collaboratively or in a distributed fashion across a network of devices, the Internet, or the cloud to collectively perform the tasks attributed to the “processor” described herein. Similarly, the term “non-transitory computer-readable storage medium” encompasses a single storage medium or a group of multiple storage media, which may be locally or remotely distributed and may collectively store and provide access to instructions, data, or other information in a coordinated or distributed manner.

In the present disclosure, an inclusive OR—meaning that it includes either A, B, or both—may be expressed as “A and/or B,” “at least one of A or B,” or “at least one selected from the group consisting of A and B.” Additionally, the expression “one of A or B,” as used herein, refers to a case where A or B is selected exclusively, but not both. The same interpretation applies in cases where three or more selectable elements are considered.

### Illustrative Embodiment

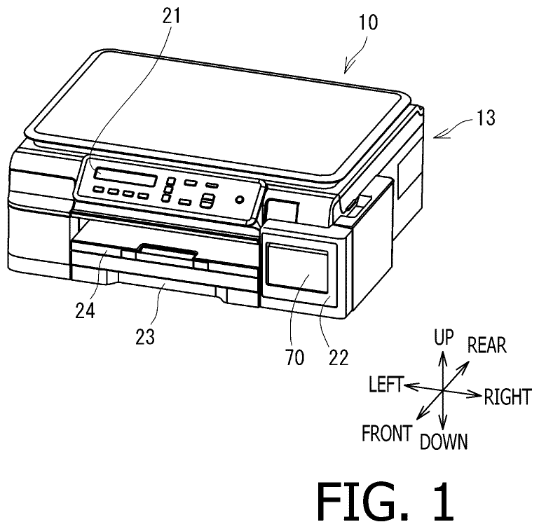

Hereinafter, an illustrative embodiment according to aspects of the present disclosure will be described with reference to the accompanying drawings. It is noted that the illustrative embodiment to be described below is merely an example of the present disclosure, and various modifications may be made without departing from the spirit and scope of the technical concepts underlying the present disclosure. In the following description, vertical directions (i.e., an upward direction and a downward direction) are defined based on a state in which a printer 10 is installed for use, as illustrated in FIG. 1. Front-rear directions (i.e., a frontward direction and a rearward direction) are defined with the frontward direction being a direction in which a feed tray 23 is pulled out from the printer 10. Left-right directions (i.e., a leftward direction and a rightward direction) are defined based on the left and right as viewed from the front side of the printer 10. Hereinafter, a representative one of the vertical directions may be referred to as “the vertical direction” in the singular form. The same applies to the front-rear directions and the left-right directions.

### External Configuration of Printer

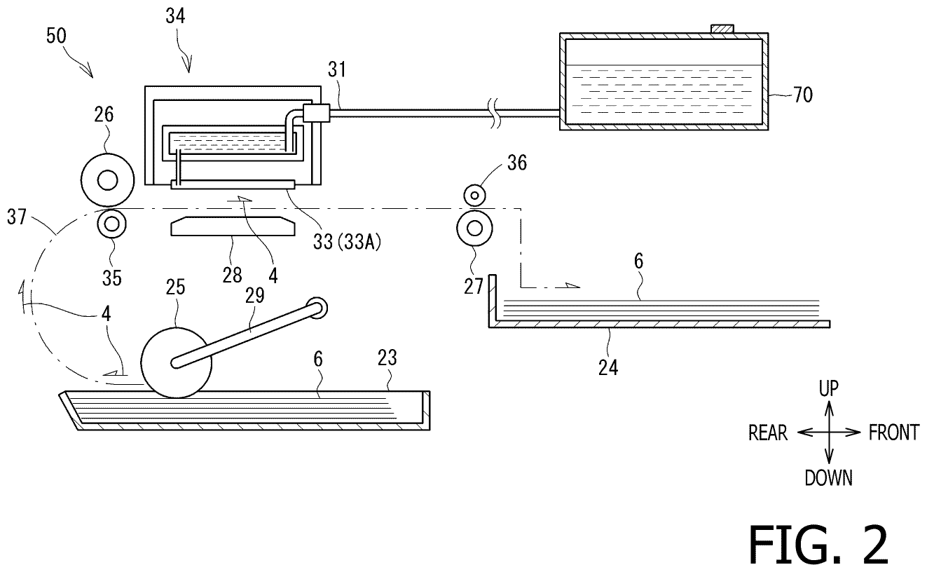

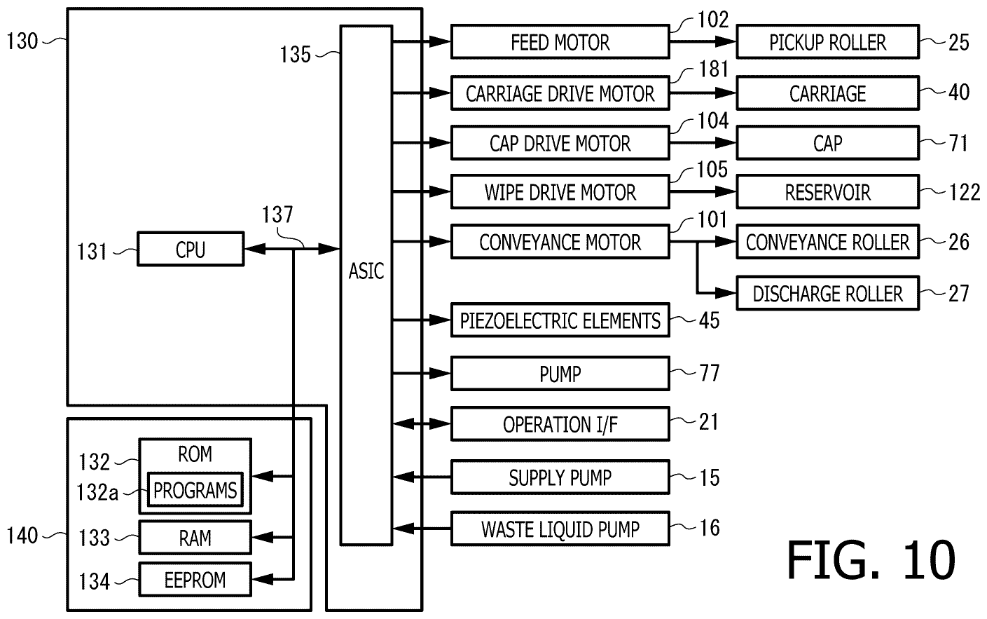

As illustrated in FIGS. 1 and 10, the printer 10 includes a housing 13. The printer 10 further includes an operation I/F 21, a cover 22, the feed tray 23, and a discharge tray 24, all of which are held by the housing 13. It is noted that “I/F” is an abbreviation for “interface.” The printer 10 further includes a controller 130 and a memory 140. The printer 10 is configured to record an image on a sheet 6 (see FIG. 2).

Feasible examples of the sheet 6 may include, but are not limited to, a cut sheet having a particular size, a sheet drawn from a roll having a cylindrical shape, and a fanfold sheet.

The operation I/F 21 includes a display and a plurality of operable switches. The operation I/F 21 is configured to receive user operations. The operation I/F 21 may include a touch panel.

As illustrated in FIG. 1, the feed tray 23 is disposed at a lower portion of the housing 13. The discharge tray 24 is disposed above the feed tray 23, at the lower portion of the housing 13. The cover 22 is disposed at a right portion of the front surface of the housing 13. The cover 22 is rotatably attached to a lower end portion of the housing 13. When the cover 22 is opened, a cartridge 70 configured to store ink becomes accessible.

Applicable examples of the illustrative embodiment are not limited to the printer 10 including one cartridge 70 configured to store a single color of ink, such as black. For instance, the printer 10 may include four cartridges 70, each configured to store ink of a corresponding one of four colors—i.e., black, yellow, cyan, and magenta.

### Print Engine

As illustrated in FIG. 2, the housing 13 includes a print engine 50 therein. The print engine 50 includes a pickup roller 25, a conveyance roller 26, a discharge roller 27, a platen 28, and a print head 34. The pickup roller 25 is rotatably supported by an arm 29. The arm 29 is pivotably supported by a frame disposed inside the housing 13. The pickup roller 25 is configured to be in contact with an uppermost one of sheets 6 placed on the feed tray 23. When a driving force from a feed motor 102 (see FIG. 10) is transmitted to the pickup roller 25, the pickup roller 25 is driven to rotate, thereby feeding the sheet 6 from the feed tray 23 into a conveyance path 37. The conveyance path 37 is a space defined by guide members (not shown). In the illustrative embodiment, the conveyance path 37 extends upward in a curved manner from a rear end of the feed tray 23 and then extends further forward.

The conveyance roller 26 and a driven roller 35 are disposed downstream of the feed tray 23 in a conveyance direction 4 in which the sheet 6 is conveyed. The driven roller 35 is urged toward the conveyance roller 26 by a spring. The driven roller 35 is disposed to face the conveyance roller 26, and is configured to hold the sheet 6 between the conveyance roller 26 and the driven roller 35. When a driving force from a conveyance motor 101 (see FIG. 10) is transmitted to the conveyance roller 26, the conveyance roller 26 is driven to rotate, thereby conveying the sheet 6 in the conveyance direction 4.

The discharge roller 27 and a driven roller 36 are disposed downstream of the conveyance roller 26 in the conveyance direction 4. The driven roller 36 is urged toward the discharge roller 27 by a spring. The driven roller 36 is disposed to face the discharge roller 27, and is configured to hold the sheet 6 between the discharge roller 27 and the driven roller 36. When the driving force from the conveyance motor 101 (see FIG. 10) is transmitted to the discharge roller 27, the discharge roller 27 is driven to rotate, thereby conveying the sheet 6 in the conveyance direction 4.

The platen 28 is disposed between the conveyance roller 26 and the discharge roller 27 in the front-rear direction. The platen 28 is configured to support the sheet 6 on its upper surface.

The print head 34 is disposed between the conveyance roller 26 and the discharge roller 27 in the front-rear direction. In addition, the print head 34 is disposed above the platen 28. The print head 34 includes an internal flow path through which ink flows. This flow path is in communication with the cartridge 70 via a tube 31. Ink is supplied from the cartridge 70 to the print head 34 through the tube 31. The print head 34 has a lower surface that serves as a nozzle surface 33A. The nozzle surface 33A extends in the front-rear direction and the left-right direction. A plurality of nozzles 33 are open in the nozzle surface 33A. When a piezoelectric element 45 (see FIG. 10) corresponding to each nozzle 33 is driven, an ink droplet is ejected from each nozzle 33.

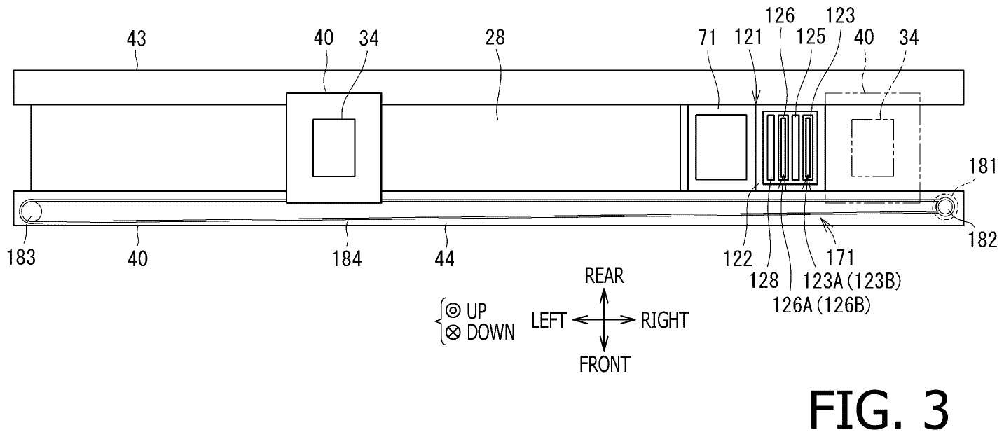

As illustrated in FIG. 3, the print head 34 is mounted on a carriage 40. The carriage 40 is movably supported by guide rails 43 and 44 extending in the left-right direction. The guide rail 44 is spaced apart from and positioned in front of the guide rail 43. The carriage 40 is connected to a belt drive mechanism 171 provided on the guide rail 44. The belt drive mechanism 171 includes a carriage drive motor 181, a driving pulley 182, a driven pulley 183, and a belt 184.

The carriage drive motor 181 is fixed to a right end portion of a lower surface of the front guide rail 44. A drive shaft of the carriage drive motor 181 extends upward. The driving pulley 182 is rotatably supported at a right end portion of an upper surface of the front guide rail 44. A rotation shaft 182A of the driving pulley 182 extends in the vertical direction and is connected to the drive shaft of the carriage drive motor 181. The driven pulley 183 is rotatably supported at a left end portion of the upper surface of the front guide rail 44. A rotation shaft 183A of the driven pulley 183 extends in the vertical direction. The belt 184 is looped around the driving pulley 182 and the driven pulley 183. Apart of the belt 184 is fixed to the carriage 40. Accordingly, the carriage 40 is configured to reciprocate along the left-right direction as a driving force from the carriage drive motor 181 is transmitted to the belt 184. The carriage 40 is movable to a position (hereinafter referred to as a “standby position”) located to the right of a wipe unit 121 to be described later. In FIG. 3, the standby position of the carriage 40 is indicated by a phantom line. The print head 34 moves integrally with the carriage 40.

Ink ejected from the plurality of nozzles 33 is aqueous ink that contains at least a water-soluble organic solvent and water. The aqueous ink is not particularly limited, provided that it contains at least a water-soluble organic solvent and water. Specifically, the aqueous ink may contain resin particles, a colorant, a water-soluble organic solvent, water, and additives. It is preferable that the viscosity of the aqueous ink be within a range from 1 mPa·s to 15 mPa·s, inclusive.

As the resin particles, for instance, particles containing at least one of methacrylic acid and acrylic acid as a monomer may be used. Commercially available products may also be used. The resin particles may further contain, for instance, styrene and/or vinyl chloride as additional monomers. The resin particles may be contained in an emulsion. The emulsion may contain the resin particles and a dispersion medium (e.g., water). The resin particles are not dissolved in the dispersion medium but are dispersed within the range of a particular particle size. Feasible examples of the resin particles may include, but are not limited to, acrylic resin, maleic acid ester resin, vinyl acetate resin, carbonate-type resin, polycarbonate-type resin, styrene-based resin, ethylene-based resin, polyethylene-based resin, propylene-based resin, polypropylene-based resin, urethane-based resin, polyurethane-based resin, polyester-based resin, and copolymer resins of these types. Among these, acrylic resin is preferable.

As the resin particles, for instance, a resin having a glass transition temperature (Tg) within a range from 0° C. to 200° C., inclusive, may be used. More preferably, Tg is within a range from 20° C. to 180° C., inclusive, and even more preferably within a range from 30° C. to 150° C., inclusive.

Commercially available emulsions may be used. Examples thereof may include, but are not limited to, “SUPERFLEX™ 870” (Tg: 71° C.) and “SUPERFLEX™ 150” (Tg: 40° C.) manufactured by Dai-ichi Kogyo Seiyaku Co., Ltd. (also known as DKS Co., Ltd.), “Mowinyl™ 6760” (Tg: −28° C.) and “Mowinyl™ DM774” (Tg: 33° C.) manufactured by Japan Coating Resin Corporation, “POLYSOL® AP-3270N” (Tg: 27° C.) manufactured by Showa Denko K.K. (whose operations are now conducted by Resonac Corporation), and “HIROS-X™ KE-1062” (Tg: 112° C.) and “HIROS-X™ QE-1042” (Tg: 69° C.) manufactured by CHEMIPAZ CORPORATION (formerly known as SEIKO PMC Corporation). It is noted that “SUPERFLEX” is a trademark of Dai-ichi Kogyo Seiyaku Co., Ltd. (also known as DKS Co., Ltd.), “Mowinyl” is a trademark of Japan Coating Resin Corporation, “POLYSOL” is a registered trademark of Resonac Corporation (formerly Showa Denko K.K.), and “HIROS-X” is a trademark of CHEMIPAZ CORPORATION (formerly known as SEIKO PMC Corporation).

The average particle diameter of the resin particles is, for instance, within a range from 30 nm to 200 nm, inclusive. The average particle diameter may be measured as an arithmetic mean diameter using a dynamic light scattering (DLS) particle size distribution analyzer, such as the “LB-550” manufactured by HORIBA, Ltd.

The content (R) of the resin particles relative to the total amount of the ink is preferably within a range from 0.1 wt % to 30 wt %, inclusive, more preferably within a range from 0.5 wt % to 20 wt %, inclusive, and particularly preferably within a range from 1.0 wt % to 15.0 wt %, inclusive. In the illustrative embodiment, acrylic resin is contained in the aqueous ink in an amount within a range from 4.6 wt % to 6.0 wt %, inclusive. A single type of resin particle may be used alone, or two or more types of resin particles may be used in combination.

As the colorant, for instance, a pigment that is dispersible in water by a pigment-dispersing resin (resin dispersant) may be used. Feasible examples of the colorant may include, but are not limited to, carbon black, inorganic pigments, and organic pigments. Feasible examples of carbon black may include, but are not limited to, furnace black, lamp black, acetylene black, and channel black. Feasible examples of inorganic pigments may include, but are not limited to, titanium oxide, iron oxide-based inorganic pigments, and carbon black-based inorganic pigments. Feasible examples of organic pigments may include, but are not limited to, azo pigments (e.g., azo lakes, insoluble azo pigments, condensed azo pigments, and chelate azo pigments), polycyclic pigments (e.g., phthalocyanine pigments, perylene and perinone pigments, anthraquinone pigments, quinacridone pigments, dioxazine pigments, thioindigo pigments, isoindolinone pigments, and quinophthalone pigments), dye lake pigments (e.g., basic dye-based lake pigments and acid dye-based lake pigments), nitro pigments, nitroso pigments, and aniline black and daylight fluorescent pigments. In the illustrative embodiment, carbon ink is used as the aqueous ink containing carbon black.

The solid content of the colorant relative to the total amount of the ink is not particularly limited, and may be appropriately determined, for instance, depending on the desired optical density or color saturation. Preferably, the solid content of the colorant relative to the total amount of the ink is within a range from 0.1 wt % to 20.0 wt %, inclusive, and more preferably within a range from 1.0 wt % to 15.0 wt %, inclusive. In the illustrative embodiment, carbon black is contained in the aqueous ink in an amount within a range from 4.0 wt % to 6.0 wt %, inclusive. The solid content of the colorant refers only to the weight of the pigment and does not include the weight of the resin particles. A single type of colorant may be used alone, or two or more types of colorants may be used in combination.

The water-soluble organic solvent is not particularly limited, and any suitable solvent may be used. Feasible examples of the water-soluble organic solvent may include, but are not limited to, propylene glycol, ethylene glycol, 1,2-butanediol, propylene glycol monobutyl ether, dipropylene glycol monopropyl ether, triethylene glycol monobutyl ether, 1,2-hexanediol, and 1,6-hexanediol. Glycol ethers having a propylene oxide group are preferable. Feasible examples of other types of organic solvents may include, but are not limited to, alkyl alcohols having one to four carbon atoms (e.g., methyl alcohol, ethyl alcohol, n-propyl alcohol, isopropyl alcohol, n-butyl alcohol, sec-butyl alcohol, and tert-butyl alcohol), alkylene glycols having an alkylene group containing two to six carbon atoms (e.g., ethylene glycol, propylene glycol, butylene glycol, triethylene glycol, 1,2,6-hexanetriol, thiodiglycol, hexylene glycol, and diethylene glycol), lower alkyl ethers of alkylene glycols, N-methyl-2-pyrrolidone, 2-pyrrolidone, and 1,3-dimethyl-2-imidazolidinone. Examples of the lower alkyl ethers of alkylene glycols may include, but are not limited to, glycerin, ethylene glycol monomethyl (or ethyl, propyl, or butyl) ether, diethylene glycol monomethyl (or ethyl, propyl, or butyl) ether, triethylene glycol monomethyl (or ethyl, propyl, butyl, or hexyl) ether, tetraethylene glycol monomethyl (or ethyl, propyl, butyl, or hexyl) ether, propylene glycol monomethyl (or ethyl, propyl, or butyl) ether, dipropylene glycol monomethyl (or ethyl, propyl, or butyl) ether, tripropylene glycol monomethyl (or ethyl, propyl, or butyl) ether, and tetrapropylene glycol monomethyl (or ethyl) ether.

It is preferable that the content of the water-soluble organic solvent relative to the total amount of the ink be equal to or less than 50 wt % for organic solvents that exist in a liquid state at 25° C. More preferably, the content of such organic solvents is equal to or less than 40 wt %. In addition, the mass ratio of the water-soluble organic solvent to the solid content in the ink—i.e., water-soluble organic solvent/solid content—is preferably equal to or greater than 1.0 in order to inhibit particles forming the solid content from coming into contact with each other. More preferably, the ratio is equal to or greater than 2.0. The solid content includes at least a pigment. In the illustrative embodiment, the solid content includes a pigment and resin particles. The water-soluble organic solvent is preferably a solvent having an evaporation rate at 20° C. that is equal to or lower than the evaporation rate of water at the same temperature. For instance, the saturated vapor pressure of water at 20° C. is approximately 2300 Pa. To reduce the evaporation rate of the ink to one-tenth of that of water, it is preferable that the saturated vapor pressure of the water-soluble organic solvent be equal to or less than 230 Pa. To reduce the evaporation rate of the ink to one-hundredth of that of water, it is more preferable that the saturated vapor pressure of the water-soluble organic solvent be equal to or less than 20 Pa. However, the saturated vapor pressure of the water-soluble organic solvent may exceed 230 Pa. In such a case, the ink tends to dry more readily and rapidly.

The water is preferably deionized water or purified water. For instance, the content of the water relative to the total amount of the ink is preferably within a range from 15 wt % to 95 wt %, inclusive, and more preferably within a range from 25 wt % to 85 wt %, inclusive. The water content may also represent the remainder of the ink after excluding the other components.

Feasible examples of additives may include, but are not limited to, surfactants, pH adjusters, viscosity modifiers, surface tension modifiers, preservatives, antifungal agents, leveling agents, defoaming agents, light stabilizers, antioxidants, nozzle-drying inhibitors, polymer components such as emulsions, and dyes. The surfactants may further include cationic surfactants, anionic surfactants, or nonionic surfactants. These surfactants may be commercially available products. Examples of such products may include, but are not limited to, “OLFINE® E1010,” “OLFINE® E1006,” and “OLFINE® E1004,” “SILFACE® SAG503A,” and “SILFACE® SAG002,” all manufactured by Nissin Chemical Industry Co., Ltd. It is noted that “OLFINE” and “SILFACE” are registered trademarks of Nissin Chemical Industry Co., Ltd. The content of the surfactant relative to the total amount of the ink is, for instance, equal to or less than 5 wt %, equal to or less than 3 wt %, or within a range from 0.1 wt % to 2 wt %, inclusive. Feasible examples of viscosity modifiers may include, but are not limited to, polyvinyl alcohol, cellulose, and water-soluble resins.

For instance, the ink may be prepared by uniformly mixing resin particles, a colorant, a water-soluble organic solvent, water, and optionally other additives as necessary, using a known method, and removing insoluble matter, e.g., using a filter.

### Cap

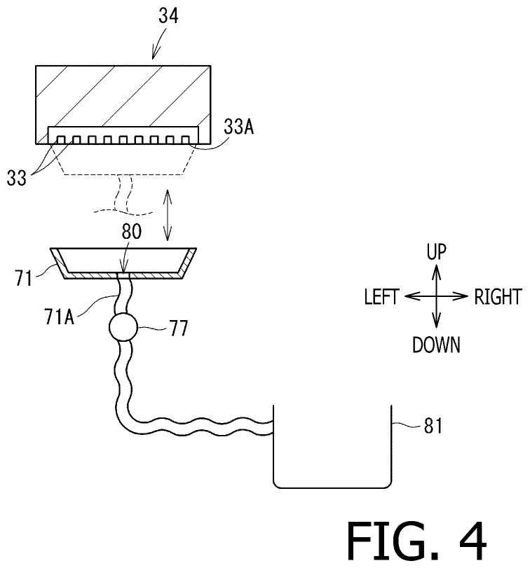

As illustrated in FIG. 3, a cap 71 is disposed to the right of the platen 28. The cap 71 is located between the guide rails 43 and 44 in the front-rear direction. The cap 71 has a cup shape that is open upward. As illustrated in FIG. 4, the cap 71 is vertically movable by a cap drive motor 104 (see FIG. 10). The cap 71 may be made entirely of an elastic material such as rubber, or may include the elastic material at least partially. As indicated by a dashed line in FIG. 4, the cap 71 is configured to come into close contact with the nozzle surface 33A of the print head 34 when the print head 34 is at a capping position, and to cover the openings of all the nozzles 33.

A waste ink tube 71A is connected to the cap 71. A discharge port 80 is formed at a bottom portion of the cap 71. One end of the waste ink tube 71A is connected to the discharge port 80. The waste ink tube 71A has an internal space configured to allow fluid to flow through it. The other end of the waste ink tube 71A is connected to a waste ink tank 81. A pump 77 is disposed at an intermediate portion of the waste ink tube 71A.

When the pump 77 is driven with the cap 71 in close contact with the nozzle surface 33A of the print head 34, the internal space of the cap 71 is depressurized, and ink is discharged from the nozzles 33 of the print head 34. The discharged ink flows from the internal space of the cap 71 through the waste ink tube 71A into the waste ink tank 81.

### Wipe Unit

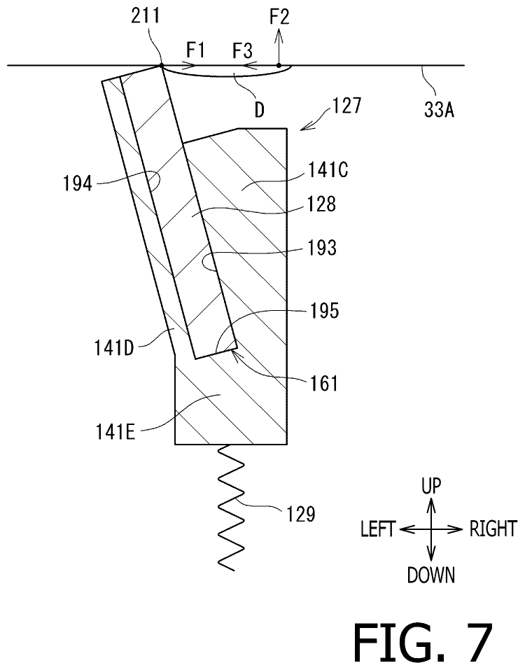

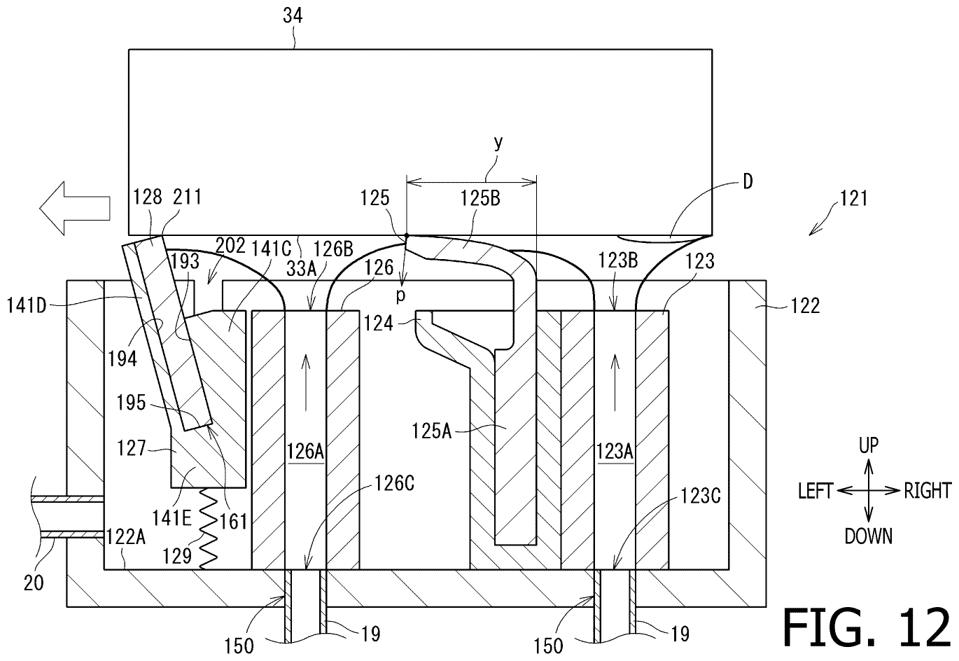

A wipe unit 121 is configured to wipe off ink adhering to the nozzle surface 33A of the print head 34. The wipe unit 121 is suitable for wiping off hardened ink D (see FIGS. 7 and 12) and high-viscosity ink. The hardened ink D refers to ink that adheres to the nozzle surface 33A after being ejected from the plurality of nozzles 33, and that has solidified and become firmly attached to the nozzle surface 33A due to drying. The high-viscosity ink refers to ink that adheres to the nozzle surface 33A after being ejected from the plurality of nozzles 33, and that has increased in viscosity due to drying. Ink adhering to the nozzle surface 33A tends to become more viscous and more firmly attached to the nozzle surface 33A as drying progresses over time. The state of ink firmly attached to the nozzle surface 33A refers to a condition in which the ink has been substantially solidified and has lost its fluidity as a liquid. In other words, it refers to a condition in which the ink has a viscosity equal to or greater than 30,000 mPa·s.

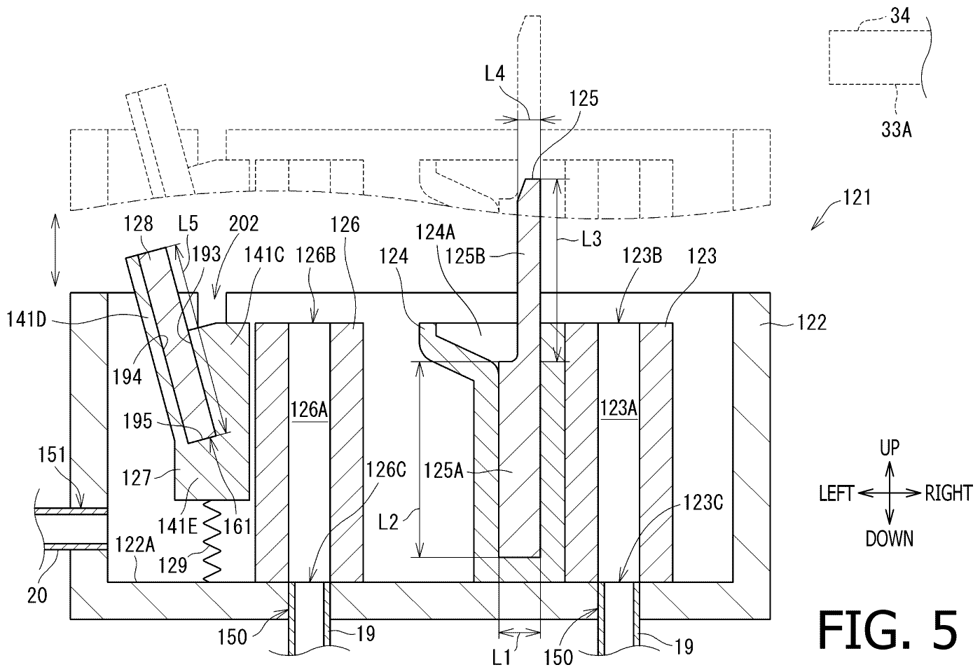

As illustrated in FIGS. 3 and 5, the wipe unit 121 includes a reservoir 122, a first discharge portion 123, a first support portion 124, a first wiper 125, a second discharge portion 126, a second support portion 127, a second wiper 128, and an urging member 129.

As illustrated in FIG. 3, the reservoir 122 is disposed to the right of the cap 71. The reservoir 122 is positioned between the guide rails 43 and 44 in the front-rear direction. The reservoir 122 is supported by a frame provided in the housing 13, in a vertically movable manner. The reservoir 122 has a box shape that is open upward. Inside the reservoir 122, the first discharge portion 123, the first wiper 125, the second discharge portion 126, and the second wiper 128 are arranged in this order from right to left in the left-right direction.

The first discharge portion 123 is fixed at a position that is displaced rightward from a center, in the left-right direction, of a bottom surface 122A of the reservoir 122. The first discharge portion 123 has a flat plate shape that extends in the front-rear direction and the vertical direction from the bottom surface 122A of the reservoir 122. The first discharge portion 123 has a first cleaning liquid flow path 123A extending in the vertical direction. The first cleaning liquid flow path 123A has a rectangular shape that is longer in the front-rear direction than in the left-right direction when viewed in the vertical direction (see FIG. 3). The first cleaning liquid flow path 123A is configured to allow cleaning liquid to flow therethrough. The first cleaning liquid flow path 123A has a first outlet 123B that is open at an upper end of the first discharge portion 123. The first outlet 123B is located below an upper end of the reservoir 122. The first outlet 123B has a rectangular shape that is longer in the front-rear direction than in the left-right direction when viewed in the vertical direction (see FIG. 3). The first cleaning liquid flow path 123A has a first inlet 123C that is open at a lower end of the first discharge portion 123. The first inlet 123C has a rectangular shape that is longer in the front-rear direction than in the left-right direction when viewed in the vertical direction (see FIG. 3).

The first support portion 124 is fixed to the bottom surface 122A of the reservoir 122. The first support portion 124 is adjacent to a left end of the first discharge portion 123. In other words, the first discharge portion 123 is adjacent to a right end of the first support portion 124. The first support portion 124 has a first wiper accommodating space 124A that is open upward. The first wiper accommodating space 124A has a substantially rectangular parallelepiped shape that is longer in the front-rear direction than in the left-right direction. A left section of the first support portion 124 is bent in such a manner that a left upper end section of the first support portion 124 extends obliquely upward to the left. As a result, an upper portion of the first wiper accommodating space 124A is gradually expanded leftward as it goes upward.

The first wiper 125 is supported by the first support portion 124. The first wiper 125 is disposed to the left of the first discharge portion 123, with the first support portion 124 interposed therebetween. In other words, the first discharge portion 123 is adjacent to the right end of the first wiper 125 via the first support portion 124. The first wiper 125 has a flat plate shape that extends in the front-rear direction and the vertical direction. Specifically, the first wiper 125 includes a base end portion 125A and a distal end portion 125B.

The base end portion 125A is press-fitted into the first wiper accommodating space 124A and fixed to the first support portion 124. Thus, the base end portion 125A is positioned in the left-right direction. A thickness L1 of the base end portion 125A in the left-right direction is, for instance, 1.5 mm. A length L2 of the base end portion 125A in the vertical direction is, for instance, within a range from 4 mm to 8 mm, inclusive.

The distal end portion 125B extends upward from an upper end of the base end portion 125A. The distal end portion 125B protrudes upward beyond the upper end of the reservoir 122 in the vertical direction. A length L3 of the distal end portion 125B in the vertical direction is, for instance, within a range from 3 mm to 7 mm, inclusive. A thickness L4 of the distal end portion 125B in the left-right direction is smaller than the thickness L1 of the base end portion 125A in the left-right direction. The thickness L4 of the distal end portion 125B is, for instance, 0.8 mm. A tip of the distal end portion 125B has a tapered shape in which it gradually decreases in thickness in the left-right direction as it goes upward.

The first wiper 125 is made entirely of elastomer, but may be formed to include elastomer at least partially. For instance, only the distal end portion 125B of the first wiper 125 may be made of elastomer. Feasible examples of elastomers may include, but are not limited to, rubber. A hardness of the first wiper 125 is equal to or greater than 45 degrees. Preferably, the hardness of the first wiper 125 is within a range from 45 degrees to 90 degrees, inclusive. A load of the first wiper 125 per unit length in the front-rear direction is within a range from 0.25 gf/mm to 0.5 gf/mm, inclusive.

The second discharge portion 126 is spaced to the left of the first support portion 124. The second discharge portion 126 is fixed to the bottom surface 122A of the reservoir 122. The second discharge portion 126 has a flat plate shape that extends in the front-rear direction and the vertical direction from the bottom surface 122A of the reservoir 122. The second discharge portion 126 has a second cleaning liquid flow path 126A extending in the vertical direction. The second cleaning liquid flow path 126A has a rectangular shape that is longer in the front-rear direction than in the left-right direction when viewed in the vertical direction (see FIG. 3). The second cleaning liquid flow path 126A is configured to allow cleaning liquid to flow therethrough. The second cleaning liquid flow path 126A has a second outlet 126B that is open at an upper end of the second discharge portion 126. The second outlet 126B has a rectangular shape that is longer in the front-rear direction than in the left-right direction when viewed in the vertical direction (see FIG. 3). The second outlet 126B is located below the upper end of the reservoir 122. The second cleaning liquid flow path 126A has a second inlet 126C that is open at a lower end of the second discharge portion 126. The second inlet 126C has a rectangular shape that is longer in the front-rear direction than in the left-right direction when viewed in the vertical direction. The second discharge portion 126 may be omitted.

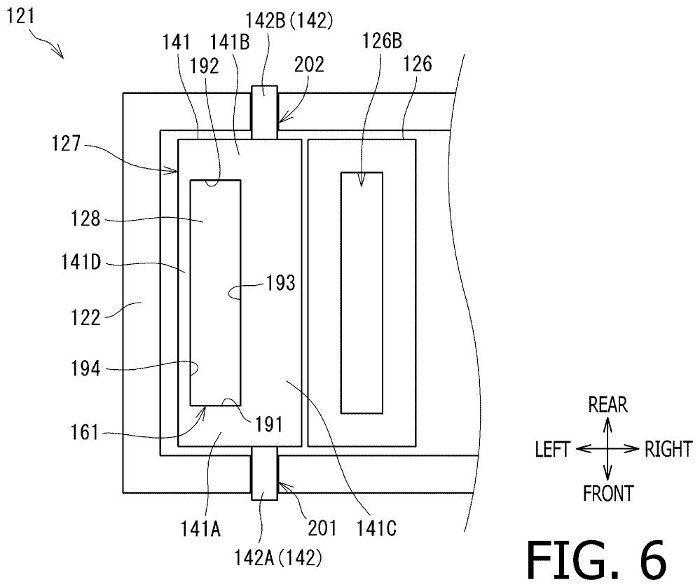

The second support portion 127 is adjacent to a left end of the second discharge portion 126. As illustrated in FIGS. 5 and 6, the second support portion 127 includes a support portion main body 141 and two bosses 142. The support portion main body 141 has a box shape with a second wiper accommodating space 161 that is open upward. Specifically, the support portion main body 141 includes a front support wall 141A, a rear support wall 141B, a right support wall 141C, a left support wall 141D, and a lower support wall 141E.

The front support wall 141A has a front inner surface 191 that defines a front end of the second wiper accommodating space 161. The rear support wall 141B has a rear inner surface 192 that defines a rear end of the second wiper accommodating space 161. The right support wall 141C has a right inner surface 193 that defines a right end of the second wiper accommodating space 161. The right inner surface 193 is slightly inclined with respect to the vertical direction in such a manner that it extends obliquely upward to the left. The left support wall 141D extends upward beyond the front support wall 141A, the rear support wall 141B, and the right support wall 141C. The left support wall 141D has a left inner surface 194 that defines a left end of the second wiper accommodating space 161. The left inner surface 194 is parallel to the right inner surface 193. The left inner surface 194 is slightly inclined with respect to the vertical direction in such a manner that it extends obliquely upward to the left. An upper end of the left inner surface 194 is located above the upper end of the reservoir 122. The lower support wall 141E has a lower inner surface 195 that defines a lower end of the second wiper accommodating space 161. The lower inner surface 195 is slightly inclined with respect to the left-right direction in such a manner that it extends obliquely upward to the right. The lower inner surface 195 is orthogonal to the right inner surface 193 and the left inner surface 194.

The two bosses 142 include a front boss 142A that extends forward from an outer surface of the front support wall 141A, and a rear boss 142B that extends rearward from an outer surface of the rear support wall 141B. The front boss 142A is disposed at an upper end portion of the outer surface of the front support wall 141A. For instance, the front boss 142A may have a quadrangular prism shape. In another instance, the front boss 142A may have a cylindrical shape. The front boss 142A is inserted into a front through hole 201 in such a manner that it is movable in the vertical direction. The front through hole 201 extends through a front wall of the reservoir 122 in the front-rear direction. The front through hole 201 extends vertically from the upper end of the reservoir 122 to substantially a central portion of the reservoir 122 in the vertical direction. An upper end of the front through hole 201 is open upward. The length of the front through hole 201 in the left-right direction is slightly greater than the length of the front boss 142A in the left-right direction.

The rear boss 142B is disposed at an upper end portion of the outer surface of the rear support wall 141B. For instance, the rear boss 142B may have a quadrangular prism shape. In another instance, the rear boss 142B may have a cylindrical shape. The rear boss 142B is inserted into a rear through hole 202 in such a manner that it is movable in the vertical direction. The rear through hole 202 extends through a rear wall of the reservoir 122 in the front-rear direction. The rear through hole 202 extends in the vertical direction from the upper end of the reservoir 122 to substantially a central portion of the reservoir 122 in the vertical direction. An upper end of the rear through hole 202 is open upward. The length of the rear through hole 202 in the left-right direction is slightly longer than the length of the rear boss 142B in the left-right direction. Accordingly, the second support portion 127 is positioned in the left-right direction by an inner surface of the front through hole 201 and an inner surface of the rear through hole 202.

Instead of the front through hole 201 and the rear through hole 202, the two bosses 142 may be inserted into grooves that extend vertically along inner surfaces of the front wall and the rear wall of the reservoir 122, in such a manner that the two bosses 142 are movable in the vertical direction.

The second wiper 128 is supported by the second support portion 127. The second wiper 128 has a rectangular parallelepiped shape that is longer in the front-rear direction than in the left-right direction. The shapes and the sizes of an upper surface and a lower surface of the second wiper 128 are substantially equal to those of the lower inner surface 195 of the lower support wall 141E. The shapes and the sizes of a left surface and a right surface of the second wiper 128 are substantially equal to those of the left inner surface 194 of the left support wall 141D.

The second wiper 128 is press-fitted into the second wiper accommodating space 161 and thus fixed to the second support portion 127. Substantially the entire left surface of the second wiper 128 is in contact with the left inner surface 194 of the left support wall 141D. Accordingly, the second wiper 128 is fixed to the second support portion 127 in such a manner that the second wiper 128 is positioned with its right corner 211 (see FIG. 7) serving as the upper end thereof. That is, the second wiper 128 is fixed to the second support portion 127 in a posture in which an upper surface of the second wiper 128 is slightly inclined relative to the nozzle surface 33A, in such a manner that the upper surface of the second wiper 128 extends obliquely downward to the left. In further other words, the second wiper 128 is fixed in a posture in which the upper surface of the second wiper 128 faces obliquely upward to the left. The upper surface of the second wiper 128 is flush with an upper surface of the second support portion 127. Assuming a posture in which the upper surface of the second wiper 128 is parallel to the nozzle surface 33A—that is, a posture in which the upper surface of the second wiper 128 faces in a direction orthogonal to the nozzle surface 33A—a length L5 in the vertical direction between the upper surface and the lower surface of the second wiper 128 is, for instance, 10 mm.

The second wiper 128 is made entirely of elastomer, but may be formed to include elastomer at least partially. For instance, only an upper portion of the second wiper 128 may be made of elastomer. Feasible examples of elastomers may include, but are not limited to, rubber. The second wiper 128 has a hardness greater than that of the first wiper 125. In other words, the hardness of the first wiper 125 is lower than that of the second wiper 128. For instance, the hardness of the second wiper 128 is equal to or greater than 60 degrees. Preferably, the hardness of the second wiper 128 is within a range from 90 degrees to 100 degrees, inclusive. A load of the second wiper 128 per unit length in the front-rear direction is within a range from 0.25 gf/mm to 4.0 gf/mm, inclusive.

The urging member 129 is configured to support the second support portion 127. The urging member 129 includes a coil spring that is compressible in the vertical direction. An upper end of the urging member 129 is attached to a lower surface of the second support portion 127. A lower end of the urging member 129 is attached to the bottom surface 122A of the reservoir 122. The urging member 129 supports the second support portion 127 in such a manner that an upper end of the second wiper 128 is positioned above the upper end of the reservoir 122 in the vertical direction. In addition, the urging member 129 supports the second support portion 127 in such a manner that the upper end of the second wiper 128 is positioned below an upper end of the first wiper 125 in the vertical direction.

The reservoir 122 of the wipe unit 121 is vertically movable between a retracted position and a contact position by a wipe drive motor 105 (see FIG. 10). The retracted position is a position in which the reservoir 122 is lowered in such a manner that the upper ends of the first wiper 125 and the second wiper 128 are positioned below the nozzle surface 33A in the vertical direction. In other words, the retracted position is a position in which the reservoir 122 is lowered in a manner that inhibits the first wiper 125 and the second wiper 128 from coming into contact with the nozzle surface 33A when the carriage 40, with the print head 34 mounted thereon, moves along the left-right direction. In FIG. 5, the retracted position is indicated by a solid line. The reservoir 122 is located at the retracted position during image recording in which the printer 10 records an image on the sheet 6.

The contact position is a position in which the reservoir 122 is raised in such a manner that the upper ends of the first wiper 125 and the second wiper 128 are located above the nozzle surface 33A in the vertical direction. In other words, the contact position is a position in which the reservoir 122 is raised in a manner that causes the first wiper 125 and the second wiper 128 to come into contact with the nozzle surface 33A when the carriage 40, with the print head 34 mounted thereon, moves along the left-right direction. The reservoir 122 is located at the contact position during a wiping process to be described later. In FIG. 5, the contact position is indicated by a phantom line.

The first wiper 125 is designed in such a manner that, when the reservoir 122 is located at the contact position and the first wiper 125 comes into contact with the nozzle surface 33A, a force P (see FIG. 12) exerted from the nozzle surface 33A satisfies the following Equation (1). That is, the first wiper 125 is designed in such a manner that the force P, calculated by the following Equation (1), falls within a range from 0.05 N to 0.5 N, inclusive.

Equation (1) is expressed as:

$$0.05 N \leq P = \frac{y}{( \frac{3 L}{2 AG} + \frac{{L}^{3}}{3 EI} )} \leq 0.5 N \qquad ( 1 )$$

In the above Equation (1), y represents a displacement amount (mm) of the first wiper 125 (see FIG. 12). L represents a length L3 (mm) of the distal end portion 125B (see FIG. 5). A represents a cross-sectional area (mm²) of the distal end portion 125B. E represents a longitudinal elastic modulus (MPa) of the distal end portion 125B. G represents a lateral elastic modulus (MPa) of the distal end portion 125B. I represents a second moment of area (mm⁴) of the distal end portion 125B.

A horizontal wiping force F1 of the second wiper 128 is set to be greater than a sum of an adhesion force F2 and a maximum static friction force F3. As illustrated in FIG. 7, the horizontal wiping force F1 refers to a force exerted when the second wiper 128 wipes off the hardened ink D while the reservoir 122 of the wipe unit 121 is at the contact position. In the illustrative embodiment, the horizontal wiping force F1 is a pressing force exerted rightward on the hardened ink D by the second wiper 128, which is urged upward by the urging member 129, when the carriage 40 moves leftward from the standby position toward the capping position. The horizontal wiping force F1 is defined as a force per unit length of the second wiper 128 in the front-rear direction.

The adhesion force F2 is defined as an adhesive force per unit area of the hardened ink D that adheres to the nozzle surface 33A. In other words, the adhesion force F2 refers to a force per unit area required to peel the hardened ink D off the nozzle surface 33A. For instance, the adhesion force F2 is 0.101 N/mm².

The maximum static friction force F3 is defined as a maximum static friction force per unit area acting between the hardened ink D and the nozzle surface 33A when the second wiper 128 presses the hardened ink D rightward, under the assumption that the hardened ink D remains on the nozzle surface 33A without being moved, and a right corner 211 of the second wiper 128 rides onto a surface of the hardened ink D opposite to another surface thereof that adheres to the nozzle surface 33A.

In the illustrative embodiment, it is preferable that the horizontal wiping force F1 be equal to or greater than 0.073 N/mm. More preferably, the horizontal wiping force F1 is set within a range from 0.073 N/mm to 0.770 N/mm, inclusive.

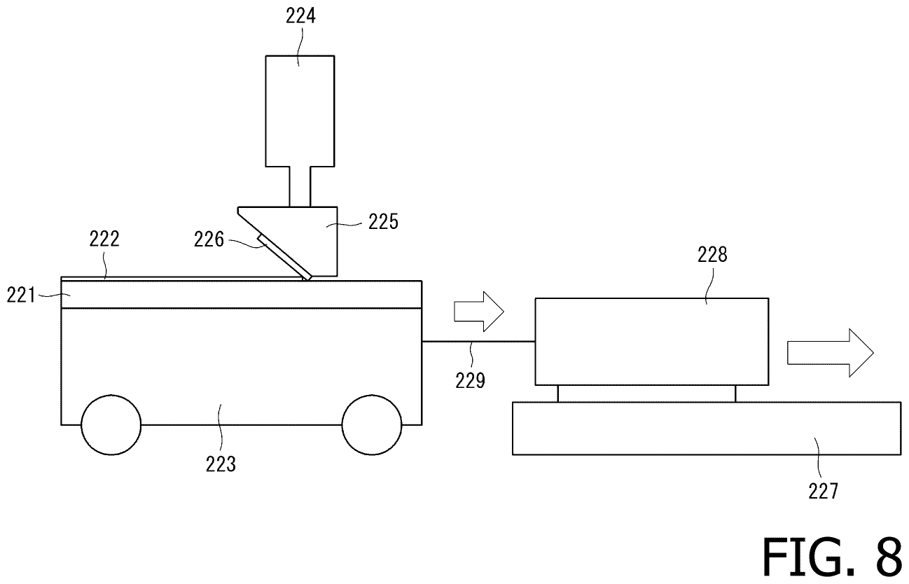

The horizontal wiping force F1 has been measured, for instance, by fabricating a model as illustrated in FIG. 8, in accordance with the following procedure. Specifically, in this measurement, a carbon film 222 is formed on a PTFE plate 221 made of a fluororesin, and the PTFE plate 221 with the carbon film 222 formed thereon is fixed to a carriage 223. The carbon film 222 has a thickness of 0.1 mm. Next, a wiper 226, which is substantially the same as the second wiper 128, is fixed to a support base 225 that has been fixed to a tension gauge 224. The wiper 226 is then pressed against an upper surface of the PTFE plate 221. The pressing force of the second wiper 128 against the PTFE plate 221 is controlled using the tension gauge 224 in such a manner that the pressing force is equal to the urging force exerted by the urging member 129 on the nozzle surface 33A through the second wiper 128 when the second wiper 128 actually comes into contact with the nozzle surface 33A. Subsequently, a digital force gauge 228 fixed to a robot cylinder 227 is connected to the carriage 223 via a wire 229.

Thereafter, the digital force gauge 228 is moved by the robot cylinder 227 in a direction away from the carriage 223, thereby pulling the carriage 223 via the wire 229. The movement speed of the digital force gauge 228 is set to be substantially equal to an actual speed at which the print head 34 moves leftward from the standby position toward the capping position while the nozzle surface 33A is in contact with the second wiper 128. For instance, the movement speed of the digital force gauge 228 is 1 mm/s.

Finally, a peeling load, which is exerted when the wiper 226 comes into contact with and peels off the carbon film 222, and a sliding load, which is exerted when the wiper 226 slides on the PTFE plate 221, are measured by the digital force gauge 228. Thus, the horizontal wiping force F1 is obtained by subtracting the sliding load from the peeling load.

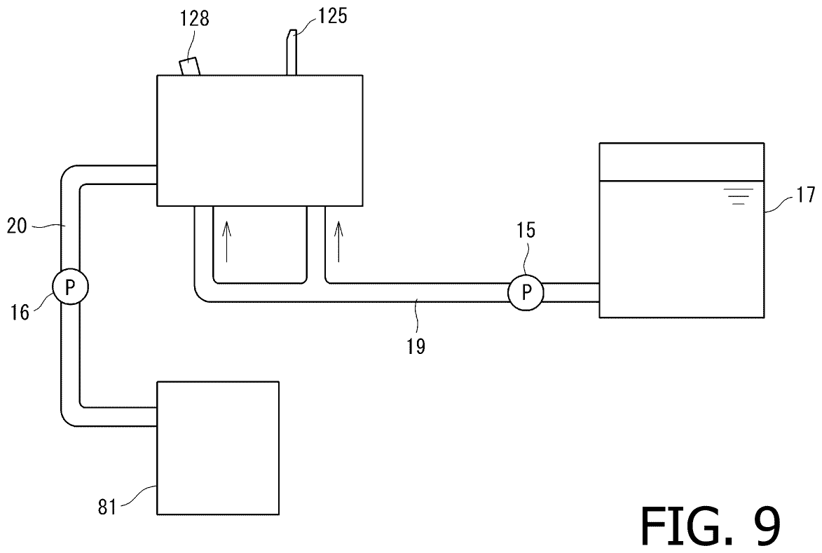

As illustrated in FIGS. 5 and 9, the first discharge portion 123 and the second discharge portion 126 of the wipe unit 121 are connected to a cleaning liquid tank 17 via a supply pipe 19. The cleaning liquid tank 17 is configured to store cleaning liquid. For instance, water is used as the cleaning liquid. One end of the supply pipe 19 is connected to the cleaning liquid tank 17. The other end of the supply pipe 19 branches into two lines, which are connected to a first inlet 123C and a second inlet 126C through two circular lower insertion holes 150, respectively. Each of the two circular lower insertion holes 150 extends through a lower wall of the reservoir 122. A supply pump 15 is disposed at an intermediate portion of the supply pipe 19.

When the supply pump 15 is driven, the cleaning liquid stored in the cleaning liquid tank 17 is supplied, through the supply pipe 19, from the first inlet 123C to the first cleaning liquid flow path 123A, and from the second inlet 126C to the second cleaning liquid flow path 126A. The cleaning liquid supplied to the first cleaning liquid flow path 123A and the second cleaning liquid flow path 126A is discharged upward from the first outlet 123B and the second outlet 126B, respectively. The driving force of the supply pump 15 is set in such a manner that the cleaning liquid discharged upward from the first outlet 123B and the second outlet 126B reaches at least the height of the nozzle surface 33A in the vertical direction. For instance, the discharge rates of the cleaning liquid from the first outlet 123B and the second outlet 126B are 0.076 mL/s.

The cleaning liquid discharged upward from the first outlet 123B and the second outlet 126B rises in the vertical direction to at least the height of the nozzle surface 33A. Thereafter, the cleaning liquid falls due to gravity and is received by the reservoir 122.

The reservoir 122 of the wipe unit 121 is connected to the waste ink tank 81 via a waste liquid pipe 20. One end of the waste liquid pipe 20 is connected to the waste ink tank 81. The other end of the waste liquid pipe 20 is connected to the interior of the reservoir 122 through a circular left insertion hole 151 that extends through a left wall of the reservoir 122. A waste liquid pump 16 is disposed at an intermediate portion of the waste liquid pipe 20. When the waste liquid pump 16 is driven, the cleaning liquid inside the reservoir 122 is discharged to the waste ink tank 81 through the waste liquid pipe 20.

### Controller and Memory

The controller 130 is configured to control various operations of the printer 10. As illustrated in FIG. 10, the controller 130 includes a CPU 131 and an ASIC 135. The memory 140 includes a ROM 132, a RAM 133, and an EEPROM 134. The CPU 131, the ASIC 135, the ROM 132, the RAM 133, and the EEPROM 134 are connected to each other via an internal bus 137.

The ROM 132 stores programs 132a for the CPU 131 to control various operations. The RAM 133 is used as a storage area for temporarily storing data and signals to be used when the CPU 131 executes the programs 132a, or as a working area for data processing. The EEPROM 134 is configured to store settings and flags that are to be retained even after the printer 10 is powered off.

The ASIC 135 is connected to the conveyance motor 101, the feed motor 102, the carriage drive motor 181, the cap drive motor 104, and the wipe drive motor 105. The ASIC 135 incorporates drive circuits for controlling these motors. The CPU 131 is configured to output drive signals for rotating the respective motors to the corresponding drive circuits. Each drive circuit is configured to output a drive current to the corresponding motor in accordance with the drive signal received from the CPU 131, thereby driving the corresponding motor to rotate. That is, the controller 130 controls the feed motor 102 to feed the sheet 6 to the conveyance path 37. In addition, the controller 130 controls the conveyance motor 101 to drive the conveyance roller 26 and the discharge roller 27 to convey the sheet 6. Further, the controller 130 controls the carriage drive motor 181 to move the carriage 40 along the left-right direction. Furthermore, the controller 130 controls the cap drive motor 104 to move the cap 71 in the vertical direction. Moreover, the controller 130 controls the wipe drive motor 105 to move the reservoir 122 in the vertical direction.

The ASIC 135 is further connected to the piezoelectric elements 45. Each piezoelectric element 45 is configured to operate when supplied with power from the controller 130 via a corresponding IC (not shown). The controller 130 controls power supply to the piezoelectric elements 45, thereby selectively causing the plurality of nozzles 33 to eject ink droplets.

When performing image recording on the sheet 6, the controller 130 alternately and repeatedly executes a conveyance process and a printing process. The conveyance process is a process in which the controller 130 drives the conveyance roller 26 and the discharge roller 27 to rotate, thereby conveying the sheet 6 by a particular line feed amount. The controller 130 performs the conveyance process by controlling the conveyance motor 101. The printing process is a process in which the controller 130 controls power supply to the piezoelectric elements 45 while moving the carriage 40 along the left-right direction, thereby causing the print head 34 to eject ink droplets from the nozzles 33.

Each time the conveyance process has been performed, the controller 130 stops the sheet 6. The controller 130 then performs the printing process while the sheet 6 remains stopped. That is, in each printing process, the controller 130 performs a single pass to cause the print head 34 to eject ink droplets from the nozzles 33 while moving the carriage 40 in the rightward or leftward direction. As a result, one pass of image recording is performed on the sheet 6. The controller 130 alternately and repeatedly executes the conveyance process and the printing process, thereby performing image recording over an entire recordable area of the sheet 6. That is, the controller 130 performs image recording on a single sheet 6 through a plurality of passes. The controller 130 drives the cap drive motor 104 to raise the cap 71, thereby bringing the cap 71 into close contact with the nozzle surface 33A of the print head 34 when the print head 34 is at the capping position. The controller 130 also drives the cap drive motor 104 to lower the cap 71, thereby separating the cap 71 from the nozzle surface 33A.

The ASIC 135 is further connected to the supply pump 15 and is configured to control driving of the supply pump 15. The ASIC 135 is also connected to the pump 77 and is configured to control driving of the pump 77. The ASIC 135 is further connected to the waste liquid pump 16 and is configured to control driving of the waste liquid pump 16.

The controller 130 is further configured to perform maintenance processing including a purge process, a wiping process, and a flushing process. For instance, the maintenance processing is performed when an elapsed time t since the previous wiping process reaches an initial elapsed time t0 stored in the EEPROM 134. The maintenance processing may also be performed at other timings, for instance, when the printer 10 is powered on or when the cartridge 70 is replaced. The maintenance processing may further be performed following completion of a printing process. In the maintenance processing, the purge process, the wiping process, and the flushing process are performed in sequence.

The purge process is a process in which ink is suctioned from the nozzles 33 by the pump 77 while the nozzles 33 are covered with the cap 71. In the purge process, a negative pressure is generated inside the cap 71 when the pump 77 is driven, whereby foreign matter is suctioned along with ink from the nozzles 33. The wiping process is a process in which the nozzle surface 33A of the print head 34 is wiped by the first wiper 125 and the second wiper 128. Details of the wiping process will be described later. The flushing process is a process in which ink is ejected toward the cap 71.

The controller 130 may be configured to perform various types of processing by the CPU 131 alone, the ASIC 135 alone, or in cooperation between the CPU 131 and the ASIC 135. Further, the controller 130 may perform the processing using either a single CPU 131 or multiple CPUs 131 that share the processing. Likewise, the controller 130 may perform the processing using either a single ASIC 135 or multiple ASICs 135 that share the processing. If the controller 130 is configured to perform various types of processing by the CPU 131, the CPU 131 may be configured to execute programs 132a stored in the ROM 132, thereby performing the processing in accordance with the flowchart to be described below. In this case, the CPU 131 may be an example of a “processor” according to aspects of the present disclosure, and the ROM 132 may be an example of a “non-transitory computer-readable storage medium” according to aspects of the present disclosure.

### Maintenance Processing

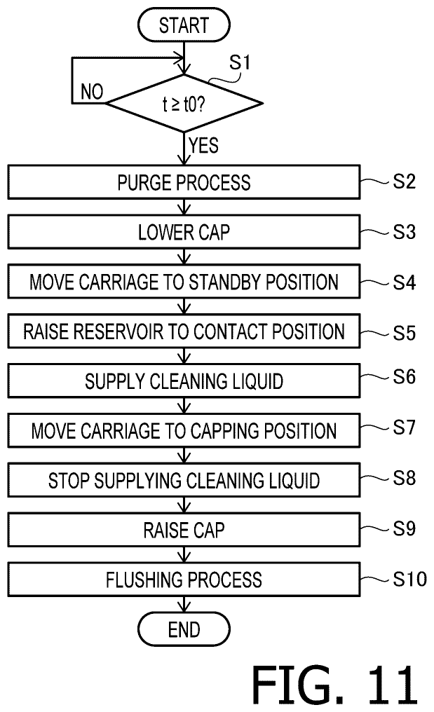

Next, with reference to FIG. 11, maintenance processing performed by the controller 130 will be described. In an initial state, the cap 71 is in close contact with the nozzle surface 33A of the print head 34. The wipe unit 121 (more specifically, the reservoir 122 of the wipe unit 121) is located at the retracted position.

The controller 130 determines whether the elapsed time t since the previous wiping process has reached the initial elapsed time t0 stored in the EEPROM 134 (S1). In response to determining that the elapsed time t has not reached the initial elapsed time t0 (S1; No), the controller 130 waits until the elapsed time t reaches the initial elapsed time to. In response to determining that the elapsed time t has reached the initial elapsed time t0 (S1; Yes), the controller 130 drives the pump 77 for a particular period of time to perform the purge process (S2). The controller 130 then drives the cap drive motor 104 to lower the cap 71 (S3). As a result, the cap 71 is separated from the nozzle surface 33A. Next, the controller 130 performs the wiping process.

The controller 130 drives the carriage drive motor 181 to move the carriage 40 rightward from the capping position to the standby position (S4). The controller 130 then drives the wipe drive motor 105 to raise the reservoir 122 of the wipe unit 121 from the retracted position to the contact position (S5). The controller 130 drives the supply pump 15 to continuously supply the cleaning liquid stored in the cleaning liquid tank 17, via the supply pipe 19, to the first cleaning liquid flow path 123A of the first discharge portion 123 and the second cleaning liquid flow path 126A of the second discharge portion 126 (S6). As a result, the cleaning liquid is continuously discharged upward from the first outlet 123B of the first cleaning liquid flow path 123A and the second outlet 126B of the second cleaning liquid flow path 126A. The cleaning liquid discharged from the first outlet 123B and the second outlet 126B rises in the vertical direction to at least the height of the nozzle surface 33A, and then falls due to gravity and is received by the reservoir 122.

The controller 130 then drives the carriage drive motor 181 to move the carriage 40 leftward from the standby position to the capping position (S7). While the carriage 40 moves leftward over the reservoir 122, the cleaning liquid that continues to be discharged from the first outlet 123B comes into contact with the nozzle surface 33A of the print head 34, and subsequently, the first wiper 125 comes into contact with the nozzle surface 33A. As a result, as illustrated in FIG. 12, a space between the nozzle surface 33A and the first wiper 125 is filled with the cleaning liquid. In such a state, the cleaning liquid comes into contact with the hardened ink D and the high-viscosity ink adhering to the nozzle surface 33A, and the first wiper 125 presses the hardened ink D and the high-viscosity ink rightward. As a result, the hardened ink D is deformed into a condition in which the cleaning liquid is allowed to more easily penetrate into the interior of the hardened ink D, and thus becomes softer. Consequently, the hardened ink D becomes more easily separable from the nozzle surface 33A. The high-viscosity ink decreases in viscosity due to contact with the cleaning liquid, and becomes more easily separable from the nozzle surface 33A.

Thereafter, the cleaning liquid that continues to be discharged from the second outlet 126B comes into contact with the nozzle surface 33A, and subsequently, the right corner 211 of the second wiper 128 is urged upward by the urging member and brought into contact with the nozzle surface 33A. As a result, as illustrated in FIG. 12, a space between the nozzle surface 33A and the second wiper 128 is filled with the cleaning liquid. In such a state, the cleaning liquid again comes into contact with the hardened ink D and the high-viscosity ink adhering to the nozzle surface 33A, and the second wiper 128 presses the hardened ink D and the high-viscosity ink rightward.

At this time, the second wiper 128 may fail to move the hardened ink D rightward, resulting in the hardened ink D remaining on the nozzle surface 33A and the right corner 211 of the second wiper 128 riding onto the surface of the hardened ink D. In such a case, the static friction force generated between the hardened ink D and the nozzle surface 33A may become so large that it becomes difficult for the second wiper 128 to wipe the hardened ink D off the nozzle surface 33A. However, the second wiper 128 has a hardness greater than that of the first wiper 125, and substantially the entire left surface of the second wiper 128 is supported by the left inner surface 194 of the left support wall 141D of the second support portion 127. Therefore, the second wiper 128 is less likely to deform and ride onto the surface of the hardened ink D. Thus, the second wiper 128 is allowed to easily wipe the hardened ink D and the high-viscosity ink off the nozzle surface 33A.

If the right corner 211 of the second wiper 128 rides onto the surface of the hardened ink D, the static friction force generated between the hardened ink D and the nozzle surface 33A may become so large that it becomes difficult for the second wiper 128 to fully wipe the hardened ink D. In the illustrative embodiment, however, the horizontal wiping force F1 of the second wiper 128 is greater than the sum of the adhesion force F2 and the maximum static friction force F3. The adhesion force F2 is defined as an adhesive force per unit area of the hardened ink D that adheres to the nozzle surface 33A, and the maximum static friction force F3 is defined as a maximum static friction force per unit area acting between the hardened ink D and the nozzle surface 33A. Therefore, the second wiper 128 is allowed to easily wipe the hardened ink D adhering to the nozzle surface 33A, even if the corner of the second wiper 128 rides onto the surface of the hardened ink D.

The controller 130 then stops the supply pump 15, thereby stopping the supply of the cleaning liquid from the cleaning liquid tank 17 (S8). Thus, the wiping process is completed. The controller 130 drives the cap drive motor 104 to raise the cap 71 into close contact with the nozzle surface 33A (S9). The controller 130 then controls power supply to the piezoelectric elements 45 and performs the flushing process to cause the print head 34 to eject ink droplets from the nozzles 33 (S10). Thus, the maintenance processing is completed.

### Advantageous Effects of Illustrative Embodiment

In the aforementioned illustrative embodiment, during the wiping process, the cleaning liquid is supplied to the nozzle surface 33A while the print head 34 moves leftward relative to the wipe unit 121. Even if ink adhering to the nozzle surface 33A has become the hardened ink D that has solidified and become firmly attached to the nozzle surface 33A due to drying, the hardened ink D is pressed leftward by the first wiper 125 while in contact with the cleaning liquid, thereby becoming deformed into a condition in which the cleaning liquid is allowed to more easily penetrate into the interior of the hardened ink D and thus becoming softened. In this softened state, the second wiper 128 presses the hardened ink D leftward. Accordingly, even if ink adhering to the nozzle surface 33A has become the hardened ink D due to drying, the second wiper 128 is allowed to easily wipe the hardened ink D off the nozzle surface 33A. Likewise, even if ink adhering to the nozzle surface 33A has become the high-viscosity ink due to drying, the high-viscosity ink decreases in viscosity due to contact with the cleaning liquid. Therefore, the high-viscosity ink becomes more easily separable from the nozzle surface 33A. Thus, the first wiper 125 and the second wiper 128 are enabled to easily wipe the high-viscosity ink off the nozzle surface 33A.

In the aforementioned illustrative embodiment, the first discharge portion 123 is disposed to the right of the first wiper 125, with the first support portion 124 interposed therebetween. In other words, the first discharge portion 123 is adjacent to the right end of the first wiper 125 via the first support portion 124. During the wiping process, the cleaning liquid is continuously discharged from the first outlet 123B to the nozzle surface 33A. As a result, a space between the nozzle surface 33A and the first wiper 125 is filled with the cleaning liquid. Accordingly, the cleaning liquid readily comes into contact with the hardened ink D and the high-viscosity ink adhering to the nozzle surface 33A, thereby making the hardened ink D and the high-viscosity ink more easily separable from the nozzle surface 33A.

In the aforementioned illustrative embodiment, the hardness of the first wiper 125 is lower than that of the second wiper 128. Therefore, damage to the nozzle surface 33A by the first wiper 125 is inhibited.

In the aforementioned illustrative embodiment, the hardness of the second wiper 128 is equal to or greater than 60 degrees. As a result, the second wiper 128 is less likely to deform when pressing the hardened ink D and the high-viscosity ink rightward. Therefore, the second wiper 128 is enabled to easily wipe the hardened ink D and the high-viscosity ink off the nozzle surface 33A.

In the aforementioned illustrative embodiment, the load of the second wiper 128 is within a range from 0.25 gf/mm to 4.0 gf/mm, inclusive. Accordingly, since the load of the second wiper 128 is equal to or less than 4.0 gf/mm, damage to the nozzle surface 33A by the second wiper 128 is inhibited. Further, since the load of the second wiper 128 is equal to or greater than 0.25 gf/mm, the second wiper 128 is allowed to easily wipe the hardened ink D and the high-viscosity ink off the nozzle surface 33A.

In the aforementioned illustrative embodiment, each of the first wiper 125 and the second wiper 128 is made entirely of elastomer. Therefore, the first wiper 125 and the second wiper 128 are more likely to come into close contact with the nozzle surface 33A. Accordingly, the first wiper 125 and the second wiper 128 are enabled to easily wipe the hardened ink D and the high-viscosity ink off the nozzle surface 33A.

In the aforementioned illustrative embodiment, the ink ejected from the plurality of nozzles 33 is aqueous ink containing at least a water-soluble organic solvent and water. The cleaning liquid discharged from the first outlet 123B and the second outlet 126B to the nozzle surface 33A is water. Therefore, since the ink and the cleaning liquid are highly compatible, the hardened ink D and the high-viscosity ink adhering to the nozzle surface 33A readily dissolve in the cleaning liquid when they come into contact with the cleaning liquid. Accordingly, the hardened ink D and the high-viscosity ink are more easily separable from the nozzle surface 33A.

In the aforementioned illustrative embodiment, even when the viscosity of aqueous ink adhering to the nozzle surface 33A varies within a range from at least 1 mPa·s to 100 mPa·s, inclusive, due to drying, the first wiper 125 and the second wiper 128 are enabled to easily wipe the aqueous ink off the nozzle surface 33A.

In the aforementioned illustrative embodiment, even when the aqueous ink adhering to the nozzle surface 33A becomes the high-viscosity ink having a viscosity of at least 1000 mPa·s due to drying, the first wiper 125 and the second wiper 128 are enabled to easily wipe the high-viscosity ink off the nozzle surface 33A.

In the aforementioned illustrative embodiment, the aqueous ink ejected from the plurality of nozzles 33 contains acrylic resin in an amount within a range from 4.0 wt % to 6.0 wt %, inclusive, and carbon black in an amount within a range from 4.0 wt % to 6.0 wt %, inclusive. Therefore, the aqueous ink adhering to the nozzle surface 33A tends to become hardened ink D, in which the acrylic resin and the carbon black have solidified and become firmly attached to the nozzle surface 33A due to drying. However, the hardened ink D is easily wiped off the nozzle surface 33A by the second wiper 128.

In the aforementioned illustrative embodiment, the horizontal wiping force F1 of the second wiper 128 is determined in consideration of not only the adhesion force F2 but also the maximum static friction force F3. The adhesion force F2 is defined as an adhesive force per unit area of the hardened ink D that adheres to the nozzle surface 33A. The maximum static friction force F3 is defined as a maximum static friction force per unit area acting between the hardened ink D and the nozzle surface 33A, under the assumption that, when the second wiper 128 presses the hardened ink D rightward, the hardened ink D remains on the nozzle surface 33A without being moved, and the right corner 211 of the second wiper 128 rides onto a surface of the hardened ink D opposite to another surface thereof that adheres to the nozzle surface 33A. Therefore, even if the right corner 211 of the second wiper 128 rides onto the surface of the hardened ink D, the second wiper 128 is allowed to easily wipe off the hardened ink D adhering to the nozzle surface 33A.

In the aforementioned illustrative embodiment, the aqueous ink ejected from the plurality of nozzles 33 is carbon ink containing carbon black. The hardness of the second wiper 128 is equal to or greater than 90 degrees. The horizontal wiping force F1 of the second wiper 128 is set to be equal to or greater than 0.073 N/mm. Therefore, even if the carbon ink adhering to the nozzle surface 33A becomes the hardened ink D that has solidified and become firmly attached to the nozzle surface 33A due to drying, the second wiper 128 is allowed to easily wipe the hardened ink D off the nozzle surface 33A.

In the aforementioned illustrative embodiment, the length L3 of the distal end portion 125B of the first wiper 125 in the vertical direction is within a range from 3 mm to 7 mm, inclusive. Therefore, a pressing force is secured for the first wiper 125 to press the nozzle surface 33A rightward. Accordingly, even if the aqueous ink adhering to the nozzle surface 33A becomes the high-viscosity ink having a viscosity that varies within a range from at least 1000 mPa·s to 10000 mPa·s, inclusive, due to drying, the first wiper 125 is allowed to easily wipe the high-viscosity ink off the nozzle surface 33A.

In the aforementioned illustrative embodiment, the hardness of the first wiper 125 is within a range from 45 degrees to 90 degrees, inclusive. Therefore, the first wiper 125 is less likely to deform when pressing the high-viscosity ink rightward. Accordingly, even if the aqueous ink adhering to the nozzle surface 33A becomes the high-viscosity ink having a viscosity that varies within a range from at least 1000 mPa·s to 10000 mPa·s, inclusive, due to drying, the first wiper 125 is allowed to easily wipe the high-viscosity ink off the nozzle surface 33A.

In the aforementioned illustrative embodiment, the first wiper 125 is designed in such a manner that, when the reservoir 122 is located at the contact position and the first wiper 125 comes into contact with the nozzle surface 33A, the force P (see FIG. 12) exerted from the nozzle surface 33A satisfies Equation (1) (which is presented again below for reference). Therefore, even if the aqueous ink adhering to the nozzle surface 33A becomes the high-viscosity ink having a viscosity that varies within a range from at least 1000 mPa·s to 10000 mPa·s, inclusive, due to drying, the first wiper 125 is allowed to easily wipe the high-viscosity ink off the nozzle surface 33A.

Equation (1) is expressed as:

$$0.05 N \leq P = \frac{y}{( \frac{3 L}{2 AG} + \frac{{L}^{3}}{3 EI} )} \leq 0.5 N \qquad ( 1 )$$

While aspects of the present disclosure have been described in conjunction with various example structures outlined above and illustrated in the drawings, various alternatives, modifications, variations, improvements, and/or substantial equivalents, whether known or that may be presently unforeseen, may become apparent to those having at least ordinary skill in the art. Accordingly, the example embodiment(s), as set forth above, are intended to be illustrative of the technical concepts according to aspects of the present disclosure, and not limiting the technical concepts. Various changes may be made without departing from the spirit and scope of the technical concepts according to aspects of the present disclosure. Therefore, the disclosure is intended to embrace all known or later developed alternatives, modifications, variations, improvements, and/or substantial equivalents. Some specific examples of potential modifications according to aspects of the present disclosure are provided below.

### Modifications

In the aforementioned illustrative embodiment, during the wiping process, the nozzle surface 33A is wiped by the first wiper 125 and the second wiper 128 while the carriage 40 with the print head 34 mounted thereon moves leftward relative to the wipe unit 121. However, it is sufficient that the nozzle surface 33A be wiped by the first wiper 125 and the second wiper 128 while the print head 34 and the wipe unit 121 move relative to each other along the left-right direction. For instance, during the wiping process, the nozzle surface 33A may be wiped by the first wiper 125 and the second wiper 128 while the print head 34 moves rightward relative to the wipe unit 121. In this case, the first discharge portion 123, the first wiper 125, the second discharge portion 126, and the second wiper 128 are arranged in this order from left to right in the left-right direction within the reservoir 122. In another instance, during the wiping process, the nozzle surface 33A may be wiped by the first wiper 125 and the second wiper 128 while the carriage 40 with the print head 34 mounted thereon moves leftward and the wipe unit 121 moves rightward.

In yet another instance, during the wiping process, the nozzle surface 33A may be wiped by the first wiper 125 and the second wiper 128 while the wipe unit 121 moves in the left-right direction relative to the print head 34. In this case, a moving mechanism may be provided to move the reservoir 122 of the wipe unit 121 in the left-right direction. Feasible examples of the moving mechanism are not particularly limited, provided that they are configured to move the reservoir 122 in the left-right direction. For instance, such feasible examples may include, but are not limited to, a gear transmission mechanism.

In the aforementioned illustrative embodiment, the first discharge portion 123 is disposed to the right of the first wiper 125, with the first support portion 124 interposed therebetween. In other words, the first discharge portion 123 is adjacent to the right end of the first wiper 125 via the first support portion 124. However, the first discharge portion 123 may be spaced to the right of the first wiper 125.

In the aforementioned illustrative embodiment, the first discharge portion 123 and the second discharge portion 126 are configured to continuously discharge the cleaning liquid to the nozzle surface 33A during the wiping process. However, the first discharge portion 123 and the second discharge portion 126 may not be configured to continuously discharge the cleaning liquid to the nozzle surface 33A during the wiping process. For instance, the first discharge portion 123 and the second discharge portion 126 may be configured to intermittently discharge the cleaning liquid to the nozzle surface 33A during the wiping process.

In the aforementioned illustrative embodiment, the hardness of the first wiper 125 is lower than that of the second wiper 128. However, the hardness of the first wiper 125 may be greater than that of the second wiper 128.

In the aforementioned illustrative embodiment, the hardness of the second wiper 128 is equal to or greater than 60 degrees. However, the hardness may be lower than 60 degrees.

In the aforementioned illustrative embodiment, the load of the second wiper 128 is within a range from 0.25 gf/mm to 4.0 gf/mm, inclusive. However, the load may be less than 0.25 gf/mm or greater than 4.0 gf/mm.

In the aforementioned illustrative embodiment, the first wiper 125 and the second wiper 128 contain elastomer. However, the first wiper 125 and the second wiper 128 may not contain elastomer.

In the aforementioned illustrative embodiment, the ink ejected from the plurality of nozzles 33 is aqueous ink containing at least a water-soluble organic solvent and water. However, feasible types of ink are not limited to aqueous ink, provided that the printer 10 is allowed to perform image recording on the sheet 6 using such ink. For instance, UV ink containing a UV-curable agent adapted to cure when exposed to ultraviolet light may be used as the ink to be ejected from the plurality of nozzles 33. The UV-curable agent may contain, for instance, a photopolymerization initiator and a polymerizable compound.

The photopolymerization initiator is a water-soluble compound adapted to cause the polymerizable compound to undergo a polymerization reaction in response to exposure to ultraviolet light. The photopolymerization initiator has a water solubility equal to or greater than 1 wt %. The solubility is determined based on the number of grams of the photopolymerization initiator dissolved in 100 g of water at 25° C. The photopolymerization initiator has a peak absorption wavelength within a range from 350 nm to 400 nm, inclusive. The peak absorption wavelength may be measured using, for instance, a UV-visible near-infrared spectrophotometer (UV-3600) manufactured by Shimadzu Corporation. The measurement of the peak absorption wavelength may be performed using, for instance, a measurement cell having a cell length of 10 mm.

As the photopolymerization initiator, for instance, an acylphosphine oxide-based initiator may be used. Examples of acylphosphine oxide-based initiators may include, but are not limited to, phenyl-2,4,6-trimethylbenzoylphosphinate lithium (peak absorption wavelength: 380 nm). Other examples of photopolymerization initiators may include, but are not limited to, 1-[4-(2-hydroxyethoxy)phenyl]-2-hydroxy-2-methyl-1-propan-1-one, 2-hydroxy-2-methyl-1-phenyl-propan-1-one, hydroxyalkylphenone-based initiators, acetophenone-based initiators, benzophenone-based initiators, benzoin-based initiators, benzoin ether-based initiators, aminoalkylphenone-based initiators, xanthone-based initiators, and oxime-based initiators. Examples of hydroxyalkylphenone-based initiators may include, but are not limited to, 1-hydroxycyclohexyl phenyl ketone and 1-(4-isopropylphenyl)-2-hydroxy-2-methylpropan-1-one. Examples of acetophenone-based initiators may include, but are not limited to, acetophenone, 2,2-diethoxyacetophenone, and p-dimethylaminoacetophenone. Examples of benzophenone-based initiators may include, but are not limited to, benzophenone, 2-chlorobenzophenone, p,p′-dichlorobenzophenone, p,p′-bis(diethylamino)benzophenone, and Michler's ketone. Examples of benzoin-based and benzoin ether-based initiators may include, but are not limited to, benzoin, benzoin methyl ether, benzoin ethyl ether, benzoin isopropyl ether, benzoin n-propyl ether, benzoin isobutyl ether, and benzoin n-butyl ether. The solid content of the photopolymerization initiator relative to the total amount of ink is preferably within a range from 0.1 wt % to 10.0 wt %, inclusive, more preferably from 0.5 wt % to 5.0 wt %, inclusive, and particularly preferably from 0.8 wt % to 2.5 wt %, inclusive.

The polymerizable compound is a water-soluble compound adapted to undergo a polymerization reaction initiated by a photopolymerization initiator in response to exposure to ultraviolet light. The polymerizable compound has a water solubility equal to or greater than 1 wt %. The polymerizable compound has two or more polymerizable functional groups. The term “polymerizable functional group” refers to a functional group adapted to undergo polymerization. Examples of polymerizable functional groups may include, but are not limited to, an acryloyl group, a methacryloyl group, a vinyl group, an allyl group, and a vinyl ether group.

Examples of polymerizable compounds may include, but are not limited to:
N,N′-1,2-ethanediylbis{N-[2-(acryloylamino)ethyl]acrylamide},
N,N′-(((2-acrylamido-2-((3-(buta-1,3-dien-2-ylamino)propoxy)-1,3-diyl)bis(oxy))bis(propane-3,1-diyl))diacrylamide,
N,N-bis(2-acrylamidoethyl)acrylamide, and
N,N′-{oxybis(ethane-2,1-diyloxy-3,1-propane-diyl)}bisacrylamide.

The solid content of the polymerizable compound relative to the total amount of ink is preferably within a range from 1.0 wt % to 40.0 wt %, inclusive, more preferably from 2.5 wt % to 40.0 wt %, inclusive, and particularly preferably from 5.0 wt % to 40.0 wt %, inclusive.

When UV ink is used as the ink to be ejected from the plurality of nozzles 33, the cleaning liquid to be discharged from the first outlet 123B and the second outlet 126B to the nozzle surface 33A may contain at least one selected from the group consisting of dipropylene glycol methyl ether acetate, diethylene glycol monoethyl ether acetate, diethylene glycol monobutyl ether acetate, dipropylene glycol monomethyl ether, diethylene glycol diethyl ether, and triethylene glycol monomethyl ether. With such a configuration, even if the ink ejected from the plurality of nozzles 33 is UV ink, since the compatibility between the UV ink and the cleaning liquid is high, the hardened ink D and the high-viscosity ink adhering to the nozzle surface 33A readily dissolve in the cleaning liquid when brought into contact with the discharged cleaning liquid. As a result, the hardened ink D and the high-viscosity ink are more easily separable from the nozzle surface 33A.

In the aforementioned illustrative embodiment, the second wiper 128 is fixed to the second support portion 127 in such a manner that the second wiper 128 is positioned with its right corner 211 serving as the upper end thereof. However, the second wiper 128 may be fixed to the second support portion 127 in a posture in which the upper surface thereof is parallel to the nozzle surface 33A.

In the aforementioned illustrative embodiment, the length L3 of the distal end portion 125B of the first wiper 125 in the vertical direction is within a range from 3 mm to 7 mm, inclusive. However, feasible examples of the present disclosure are not limited to this configuration.

In the aforementioned illustrative embodiment, assuming a posture in which the upper surface of the second wiper 128 faces in the direction orthogonal to the nozzle surface 33A, the length L5 in the vertical direction between the upper surface and the lower surface of the second wiper 128 is 10 mm. However, the length L5 may be, for instance, equal to or less than 0.5 mm. It is noted that the vertical direction may be an example of the direction orthogonal to the nozzle surface 33A. With such a configuration, even if the hardness of the second wiper 128 is low, the second wiper 128 is less likely to deform leftward when pressing the nozzle surface 33A rightward. Accordingly, even if the hardness of the second wiper 128 is low, the second wiper 128 is allowed to easily wipe the hardened ink D off the nozzle surface 33A. Reducing the hardness of the second wiper 128 inhibits the nozzle surface 33A from being damaged by the second wiper 128. In this case, the front support wall 141A, the rear support wall 141B, the right support wall 141C, and the left support wall 141D of the second support portion 127 may be omitted. In other words, only the lower surface of the second wiper 128 may be fixed to the lower inner surface 195 of the lower support wall 141E of the second support portion 127 using, for instance, an adhesive. Since the length L5 of the second wiper 128 is short, the second wiper 128 is less likely to deform leftward even when the left surface thereof is not fixed to the second support portion 127. Accordingly, the second wiper 128 is allowed to easily wipe the hardened ink D off the nozzle surface 33A.

The following provides examples of associations between elements set forth in the aforementioned illustrative embodiment(s) and modification(s), and elements claimed according to aspects of the present disclosure. For instance, the printer 10 may be an example of an “ink ejection device” according to aspects of the present disclosure. The print head 34 may be an example of a “head” according to aspects of the present disclosure. The nozzle surface 33A may be an example of a “nozzle surface” according to aspects of the present disclosure. The nozzles 33 may be included as examples of a “nozzle” according to aspects of the present disclosure. The belt drive mechanism 171 may be an example of a “drive assembly” according to aspects of the present disclosure. The wipe unit 121 may be an example of a “wipe unit” according to aspects of the present disclosure. The first discharge portion 123 may be an example of a “discharge portion” according to aspects of the present disclosure. The first wiper 125 may be an example of a “first wiper” according to aspects of the present disclosure. The second wiper 128 may be an example of a “second wiper” according to aspects of the present disclosure. The first support portion 124 may be an example of a “support portion” according to aspects of the present disclosure. The base end portion 125A may be an example of a “base end portion” according to aspects of the present disclosure. The distal end portion 125B may be an example of a “distal end portion” according to aspects of the present disclosure.

What is claimed is:

1. An ink ejection device comprising:
a head having a nozzle surface in which a nozzle is open, the head being configured to eject ink from the nozzle;
a wipe unit configured to wipe the nozzle surface; and
a drive assembly configured to move the head and the wipe unit relative to each other along a first direction,
wherein the wipe unit comprises:
a discharge portion configured to discharge cleaning liquid to the nozzle surface; and
a first wiper and a second wiper configured to come into contact with the nozzle surface, and
wherein the discharge portion, the first wiper, and the second wiper are arranged in this order in the first direction.

2. The ink ejection device according to claim 1,
wherein the discharge portion is adjacent to the first wiper in the first direction, and
wherein the discharge portion is further configured to continuously discharge the cleaning liquid to the nozzle surface while the head and the wipe unit move relative to each other along the first direction, thereby filling a space between the nozzle surface and the first wiper with the cleaning liquid.

3. The ink ejection device according to claim 1,
wherein a hardness of the first wiper is lower than a hardness of the second wiper.

4. The ink ejection device according to claim 3,
wherein the hardness of the second wiper is equal to or greater than 60 degrees.

5. The ink ejection device according to claim 4,
wherein a load of the second wiper is within a range from 0.25 gf/mm to 4.0 gf/mm, inclusive.

6. The ink ejection device according to claim 1,
wherein the first wiper and the second wiper contain elastomer.

7. The ink ejection device according to claim 1,
wherein the ink ejected from the nozzle has a viscosity that varies within a range from 1 mPa·s to 100 mPa·s, inclusive, due to drying while the ink adheres to the nozzle surface.

8. The ink ejection device according to claim 1,
wherein the ink ejected from the nozzle has a viscosity of at least 1000 mPa·s due to drying while the ink adheres to the nozzle surface.

9. The ink ejection device according to claim 7,
wherein the ink ejected from the nozzle contains:
acrylic resin in an amount within a range from 4.0 wt % to 6.0 wt %, inclusive; and
carbon black in an amount within a range from 4.0 wt % to 6.0 wt %, inclusive.

10. The ink ejection device according to claim 8,
wherein the ink ejected from the nozzle contains:
acrylic resin in an amount within a range from 4.0 wt % to 6.0 wt %, inclusive; and
carbon black in an amount within a range from 4.0 wt % to 6.0 wt %, inclusive.

11. The ink ejection device according to claim 1,
wherein a horizontal wiping force of the second wiper is set to be greater than a sum of an adhesion force of hardened ink and a maximum static friction force between the hardened ink and the nozzle surface,
wherein the horizontal wiping force is defined as a force, per unit length of the second wiper in the first direction, exerted by the second wiper to press the hardened ink in the first direction, the hardened ink referring to ink that, while adhering to the nozzle surface, has solidified and become firmly attached to the nozzle surface due to drying,
wherein the adhesion force is defined as an adhesive force per unit area of the hardened ink that adheres to the nozzle surface, and
wherein the maximum static friction force is defined as a force per unit area that acts between the hardened ink and the nozzle surface when the second wiper presses the hardened ink in the first direction, under an assumption that the hardened ink remains on the nozzle surface and an end of the second wiper in the first direction rides onto a surface of the hardened ink opposite to another surface thereof that adheres to the nozzle surface.

12. The ink ejection device according to claim 11,
wherein ink ejected from the nozzle is carbon ink containing carbon black,
wherein a hardness of the second wiper is within a range from 90 degrees to 100 degrees, inclusive, and
wherein the horizontal wiping force is within a range from 0.073 N/mm to 0.770 N/mm, inclusive.

13. The ink ejection device according to claim 11,
wherein the ink ejected from the nozzle has a viscosity that varies within a range from 1000 mPa·s to 10000 mPa·s, inclusive, due to drying while the ink adheres to the nozzle surface,
wherein a hardness of the first wiper is within a range from 45 degrees to 90 degrees, inclusive,
wherein a hardness of the second wiper is higher than the hardness of the first wiper,
wherein the horizontal wiping force is within a range from 0.073 N/mm to 0.770 N/mm, inclusive, and
wherein a discharge rate of water discharged from the discharge portion is equal to or greater than 0.076 mL/s.

14. The ink ejection device according to claim 1,
wherein a length of the second wiper in a second direction orthogonal to the nozzle surface is equal to or less than 0.5 mm.

15. The ink ejection device according to claim 1,
wherein the wipe unit further comprises a support portion configured to support the first wiper,
wherein the first wiper comprises:
a base end portion fixed to the support portion and positioned in the first direction; and
a distal end portion extending from the base end portion in a second direction orthogonal to the nozzle surface, the distal end portion having a length in the second direction within a range from 3 mm to 7 mm, inclusive, and
wherein the ink ejected from the nozzle has a viscosity that varies within a range from 1000 mPa·s to 10000 mPa·s, inclusive, due to drying while the ink adheres to the nozzle surface.

16. The ink ejection device according to claim 1,
wherein the ink ejected from the nozzle has a viscosity that varies within a range from 1000 mPa·s to 10000 mPa·s, inclusive, due to drying while the ink adheres to the nozzle surface, and
wherein a hardness of the first wiper is within a range from 45 degrees to 90 degrees, inclusive.

17. The ink ejection device according to claim 1,
wherein the ink ejected from the nozzle has a viscosity that varies within a range from 1000 mPa·s to 10000 mPa·s, inclusive, due to drying while the ink adheres to the nozzle surface,
wherein the wipe unit further comprises a support portion configured to support the first wiper,
wherein the first wiper includes:
a base end portion fixed to the support portion and positioned in the first direction; and
a distal end portion extending from the base end portion in a second direction orthogonal to the nozzle surface,
wherein a hardness of the first wiper is within a range from 45 degrees to 90 degrees, inclusive, and
wherein a force P exerted from the nozzle surface to the first wiper when the first wiper comes into contact with the nozzle surface satisfies Equation (1) expressed as:
$$0.05 N \leq P = \frac{y}{( \frac{3 L}{2 AG} + \frac{{L}^{3}}{3 EI} )} \leq 0 \text{.5} N , \qquad ( 1 )$$
where y represents a displacement amount (mm) of the distal end portion,
L represents a length (mm) of the distal end portion,
A represents a cross-sectional area (mm²) of the distal end portion,
E represents a longitudinal elastic modulus (MPa) of the distal end portion,
G represents a lateral elastic modulus (MPa) of the distal end portion, and
I represents a second moment of area (mm⁴) of the distal end portion.

18. The ink ejection device according to claim 1,
wherein the ink ejected from the nozzle is aqueous ink containing at least a water-soluble organic solvent and water, and
wherein the cleaning liquid discharged from the discharge portion to the nozzle surface is water.

19. The ink ejection device according to claim 1,
wherein the ink ejected from the nozzle is UV ink containing a UV-curable agent adapted to cure when exposed to ultraviolet light, and
wherein the cleaning liquid discharged from the discharge portion to the nozzle surface contains at least one selected from the group consisting of:
dipropylene glycol methyl ether acetate;
diethylene glycol monoethyl ether acetate;
diethylene glycol monobutyl ether acetate;
dipropylene glycol monomethyl ether;
diethylene glycol diethyl ether; and
triethylene glycol monomethyl ether.
